(19) United States
(12) Patent Application Publication
(10) Pub. No.: US 2022/0205498 A1
(43) Pub. Date: Jun. 30, 2022

(54) RAIL CLAMP WITH ROTATABLE BRAKE SHOE

(71) Applicant: HILLMAR INDUSTRIES LIMITED, Delta (CA)

(72) Inventor: Dimiter Mintchev, Delta (CA)

(73) Assignee: HILLMAR INDUSTRIES LIMITED, Delta, BC (CA)

(21) Appl. No.: 17/594,727

(22) PCT Filed: Apr. 30, 2020
(86) PCT No.: PCT/CA2020/050576

§ 371 Date: Oct. 27, 2021

Related U.S. Application Data
(60) Provisional application No. 62/841,176, filed on Apr. 30, 2019.

(51) Int. Cl. F16D 63/00

(52) U.S. Cl. CPC F16D 63/008; F16D 2125/64

(57) ABSTRACT

A braking mechanism comprises: a frame; a first lever mounted to the frame for rotation about a first fulcrum; and a first brake shoe rotatably connected to the first lever for rotation about a first brake shoe axis spaced apart from the first fulcrum, the first brake shoe comprising a first brake pad and positioned to press against a rail.

### CROSS-REFERENCE TO RELATED APPLICATION

This application claims the benefit of, and priority to, U.S. provisional patent application No. 62/841,176 filed Apr. 30, 2019.

### FIELD

This disclosure relates generally to rail clamps.

### RELATED ART

Some rail clamps include a pair of levers. Each of the levers may be pivotable about a respective lever axis, and each of the levers may have a brake pad at an end thereof. When the rail is between the brake pads, the levers may be pivoted around their respective axes to clamp the brake pads against the rail.

However, the rail may wear and become thinner over time. As the rail becomes thinner, when the levers are pivoted around their respective lever axes to clamp the brake pads against the rail, the brake pads may contact the rail at contact points farther from the lever axes when compared to contact points where the brake pads contact the rail before the rail wears and becomes thinner. When the brake pads contact the rail at contact points farther from the lever axes, the brake pads clamp the rail with less force.

### SUMMARY

At least one embodiment disclosed herein may provide a novel and improved spring actuated braking mechanism with improved braking effect.

Some embodiments disclosed herein may include one or more spring-actuated, hydraulically-released brakes for cranes or for other material-handling equipment.

There is provided, according to at least one embodiment disclosed herein, a braking mechanism for a rail, the braking mechanism comprising a frame and a lever pivotally mounted to the frame for pivoting about a lever axis. In some embodiments, a brake shoe is pivotally connected to the lever for pivoting about a brake shoe axis which is parallel to the lever axis. In some embodiments, the brake shoe has a brake pad thereon positioned to press against the rail. In some embodiments, pivoting of the brake shoe about the brake shoe axis may ensure alignment between the brake pad and the rail for different pivotal positions of the lever with respect to the lever axis.

In some embodiments, there is a second lever with a second brake shoe. In some embodiments, the levers and brake shoes oppose each other with the brake pads thereof being spaced apart to receive the rail therebetween and clamp the rail between the brake pads when the levers are pivoted about the lever axes to press the brake pads against the rail.

There is also provided, according to at least one embodiment disclosed herein, a braking mechanism for clamping a rail, the braking mechanism including a frame and a lever having a first end and a second end. In some embodiments, a brake shoe is pivotally mounted near the first end of the lever. In some embodiments, the brake shoe has a brake pad thereon for frictionally engaging the rail. In some embodiments, there is a cam and a spring which biases the cam in a first direction. In some embodiments, a clamp release actuator is operable to displace the cam in a second direction which is opposite to the first direction. In some embodiments, a variably sloped cam surface is disposed on a side of the cam. In some embodiments, the variably sloped cam surface may be in contact with the cam follower. In some embodiments, the variably sloped cam surface has a slope which varies to counteract variations in a spring force of the spring as the cam is displaced, thereby maintaining a constant braking force.

There is also provided, according to at least one embodiment disclosed herein, a braking mechanism for a rail, the braking mechanism comprising: a frame; a first lever mounted to the frame for rotation about a first fulcrum; and a first brake shoe rotatably connected to the first lever for rotation about a first brake shoe axis spaced apart from the first fulcrum, the first brake shoe comprising a first brake pad and positioned to press against the rail.

In some embodiments, the first lever is pivotally mounted to the frame for pivoting about a first lever axis spaced apart from the first brake shoe axis.

In some embodiments, the first brake shoe axis is parallel to the first lever axis.

In some embodiments, the first brake shoe is pivotally connected to the first lever for pivoting about the first brake shoe axis.

In some embodiments, the braking mechanism further comprises: a second lever mounted to the frame for rotation about a second fulcrum; and a second brake shoe rotatably connected to the second lever for rotation about a second brake shoe axis spaced apart from the second fulcrum, the second brake shoe comprising a second brake pad and positioned to press against the rail. In some embodiments, the first and second brake pads spaced apart from each other to receive the rail between the first and second brake pads and to clamp the rail between the first and second brake pads when the first and second levers are rotated about the first and second fulcrums respectively to press the first and second brake pads against the rail.

In some embodiments, the second lever is pivotally mounted to the frame for pivoting about a second lever axis spaced apart from the second brake shoe axis.

In some embodiments, the second brake shoe axis is parallel to the second lever axis.

In some embodiments, the second brake shoe is pivotally connected to the second lever for pivoting about the second brake shoe axis.

In some embodiments, the braking mechanism further comprises at least one resilient body biasing the first and second brake pads towards engagement with the rail.

In some embodiments, the at least one resilient body is a spring mechanism.

In some embodiments, the braking mechanism further comprises a clamp actuator actuatable to counter the at least one resilient body by moving the first and second brake pads away from engagement with the rail.

In some embodiments, the clamp actuator comprises a cam mechanism.

In some embodiments: the first brake pad and the first brake shoe are near a brake end of the first lever; the second brake pad and the second brake shoe are near a brake end of the second lever; the braking mechanism further comprises a first cam follower near a cam end of the first lever opposite the brake end of the first lever and positioned to contact a first cam surface of the cam mechanism such that movement of the cam mechanism causes rotation of the first lever about the first fulcrum; and the braking mechanism further comprises a second cam follower near a cam end of the second lever opposite the brake end of the second lever and positioned to contact a second cam surface of the cam mechanism such that movement of the cam mechanism causes rotation of the second lever about the second fulcrum.

In some embodiments: the first cam follower is a first roller rotatably mounted on the first lever; and the second cam follower is a second roller rotatably mounted on the second lever.

In some embodiments, the first and second cam surfaces are variably sloped.

There is also provided, according to at least one embodiment disclosed herein, a braking system comprising: the braking mechanism; and the rail positioned such that the first brake pad is positionable to press against the rail in response to rotation of the first lever about the first fulcrum.

In some embodiments, the rail is positioned such that the second brake pad is positionable to press against the rail in response to rotation of the second lever about the second fulcrum.

There is also provided, according to at least one embodiment disclosed herein, a method of operating the braking system, the method comprising: causing the first and second brake pads to move away from engagement with the rail; wherein causing the first and second brake pads to move away from engagement with the rail comprises causing the cam mechanism to move.

There is also provided, according to at least one embodiment disclosed herein, a crane comprising the braking mechanism.

There is also provided, according to at least one embodiment disclosed herein, material-handling equipment comprising the braking mechanism.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 is a perspective, partially in-section view of a rail clamp with pivotally mounted brake shoes according to an embodiment disclosed herein;

FIG. 2 is a side elevation view showing the rail clamp of FIG. 1 in a released position;

FIG. 3 is a side elevation view showing the rail clamp of FIG. 1 in an engaged position;

FIG. 4 is a simplified, fragmentary side elevation view of the rail clamp of FIG. 1, showing a lever and a brake shoe of the rail clamp of FIG. 1 in a first position where the brake shoe is disengaged from a rail of FIG. 1;

FIG. 5 is a simplified, fragmentary side elevation view of the lever of FIG. 4 in a second position where the brake shoe of FIG. 4 partially engages the rail of FIG. 4;

FIG. 6 is a simplified, fragmentary side elevation view of the lever of FIG. 4 in a third position where the brake shoe FIG. 4 fully engages the rail of FIG. 4;

FIG. 7 is an enlarged simplified, fragmentary side elevation view of the lever of FIG. 4 in the second position of FIG. 5, where the brake shoe FIG. 4 partially engages the rail of FIG. 4;

FIG. 8 is an enlarged simplified, fragmentary side elevation view of the constant force rail clamp in the third position of FIG. 6, where the brake shoe FIG. 4 fully engages the rail of FIG. 4;

FIG. 9 is a simplified, fragmentary side elevation view of a lever and a brake shoe according to another embodiment disclosed herein;

FIG. 10 is an enlarged simplified, fragmentary side elevation view of the lever and the brake shoe of FIG. 9;

FIG. 11 is a simplified, fragmentary front elevation view of the lever of FIG. 9;

FIG. 12 is an enlarged simplified, fragmentary side elevation view of the lever of FIG. 9;

FIG. 13 is a simplified, top plan view of the brake shoe of FIG. 9;

FIG. 14 is a simplified, fragmentary side elevation view of lever of FIG. 9 urged against a contact surface of a rail when the rail has a first thickness;

FIG. 15 is a simplified, fragmentary side elevation view of lever of FIG. 9 urged against the contact surface of the rail of FIG. 14 when the rail has a second thickness less than the first thickness;

FIG. 16 is a simplified front elevation view of a lever and a brake shoe according to another embodiment disclosed herein; and

FIG. 17 is a simplified side elevation view of the lever and the brake shoe of FIG. 16.

### DETAILED DESCRIPTION

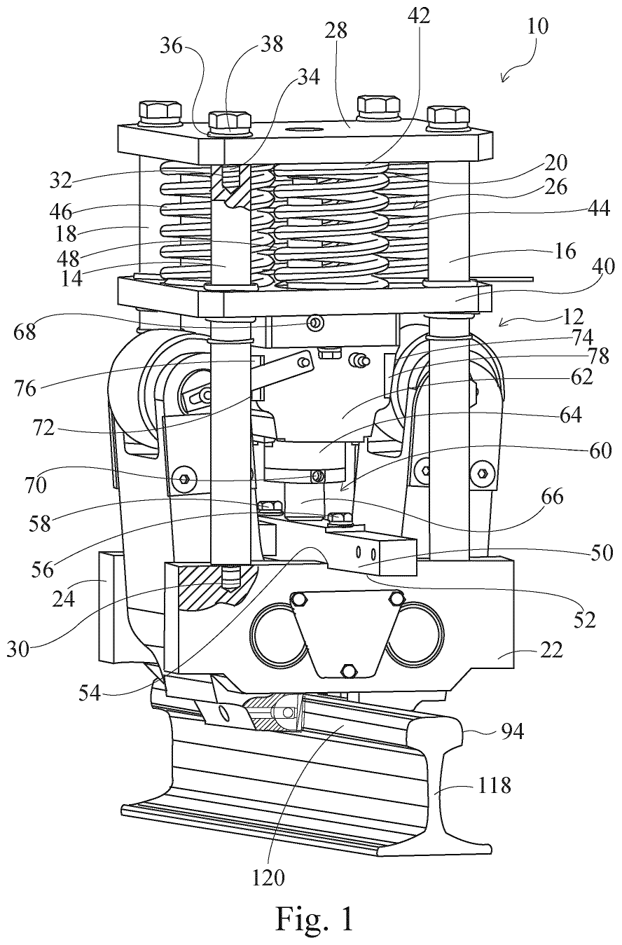

Referring to the drawings, and first to FIG. 1, this shows a rail clamp 10 according to one embodiment disclosed herein. The rail clamp 10 has a frame 12 which, in this example, includes four spaced-apart guide posts 14, 16, 18, and 20. The guide posts 14, 16, 18, and 20 connect a pair of mounting plates 22 and 24 to a spring mechanism 26. A first pair of the guide posts 14 and 16 connect a first one of the mounting plates 22 to a top plate 28 of the spring mechanism 26. A second pair of the guide posts 18 and 20 connect a second one of the mounting plates 24 to the top plate 28 of the spring mechanism 26. As shown for one of the guide posts 14, each guide post has a threaded first end 30 which is in threaded engagement with a corresponding one of the mounting plates (the first one of the mounting plates 22 in the case of the guide post 14). Again as shown for one of the guide posts 14, each of the guide posts also has a threaded bore 32 at a second end thereof. This allows for threaded engagement with a bolt 34 which, with a pair of washers 36 and 38, secures the guide post 14 to the top plate 28 of the spring mechanism 26.

The frame 12 and the guide posts 14, 16, 18, and 20 are examples only, and alternative embodiments may differ. For example, alternative embodiments may include more or fewer guide posts, one or more guide posts that differ from the guide posts 14, 16, 18, and 20, one or more alternatives to the guide posts, or a different frame that may or may not include guide posts, for example.

A bottom plate 40 of the spring mechanism 26 is substantially rectangular and has a bore (not shown) near each corner thereof. The guide posts 14, 16, 18, and 20 each slidingly extend through a corresponding one of the bores so that the bottom plate 40 of the spring mechanism 26 is slidable along the guide posts 14, 16, 18, and 20. The spring mechanism 26 also includes at least one resilient body, namely helical compression springs 42, 44, 46, and 48 in the embodiment shown. The compression springs 42, 44, 46, and 48 extend longitudinally between the top plate 28 and the bottom plate 40 of the spring mechanism 26. In this example, there are four compression springs. However, it will be understood by a person skilled in the art that any suitable number or type of springs may be used, and that alternative embodiments may include one or more alternatives to the helical compression springs or one or more other resilient bodies. More generally, the spring mechanism 26 is an example only, and alternative embodiments may differ.

A crossbar 50 extends between the mounting plates 22 and 24. A bottom side 52 of the crossbar 50 is received by recesses in the tops of the mounting plates 22 and 24. In FIG. 1, only a recess 54 in one of the mounting plates 22 is shown. Bolts 56 and 58 fasten the crossbar 50 to the mounting plates 22 and 24. The pair of mounting plates 22 and 24 and the crossbar 50 are also an example only, and alternative embodiments may differ. For example, alternative embodiments may include one or more alternatives to the mounting plates 22 and 24 or one or more alternatives to the crossbar 50.

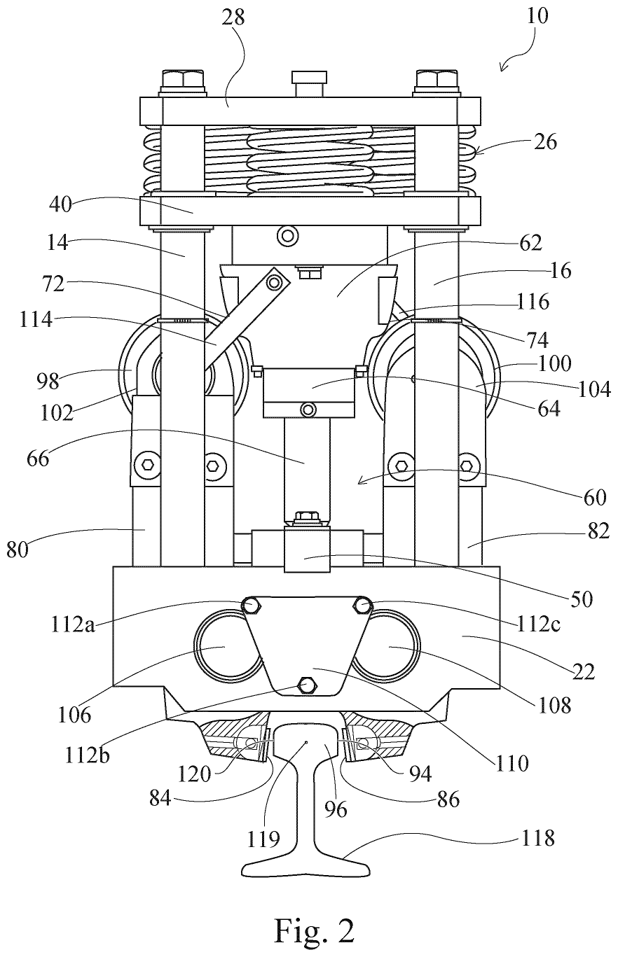

A clamp actuator 60 is disposed between the crossbar 50 and the spring mechanism 26. The clamp actuator 60 comprises a variably sloped cam or cam mechanism, in the form of a wedge 62, a cylinder 64 on which the wedge 62 is mounted, and a piston rod 66 which is mounted on the crossbar 50. Ports 68 and 70 and fluid conduits (not shown) connected to the ports 68 and 70 allow pressurized fluid (such as hydraulic fluid, for example) to flow to and from the cylinder 64 to move the piston rod 66 relative to the cylinder 64. The wedge 62 is operatively connected to the bottom plate 40 of the spring mechanism 26. Variably sloped wedge surfaces 72 and 74, shown in FIG. 2, for example, are disposed on opposite sides of the wedge 62. The variably sloped wedge surfaces 72 and 74 may be formed, at least in part, by profiled inserts 76 and 78 respectively. The inserts 76 and 78 are replaceable allowing for easy maintenance should they become damaged or worn. The clamp actuator 60 is also an example only, and alternative embodiments may differ. For example, alternative embodiments may include one or more alternatives to the wedge 62 or one or more alternatives to the cylinder 64.

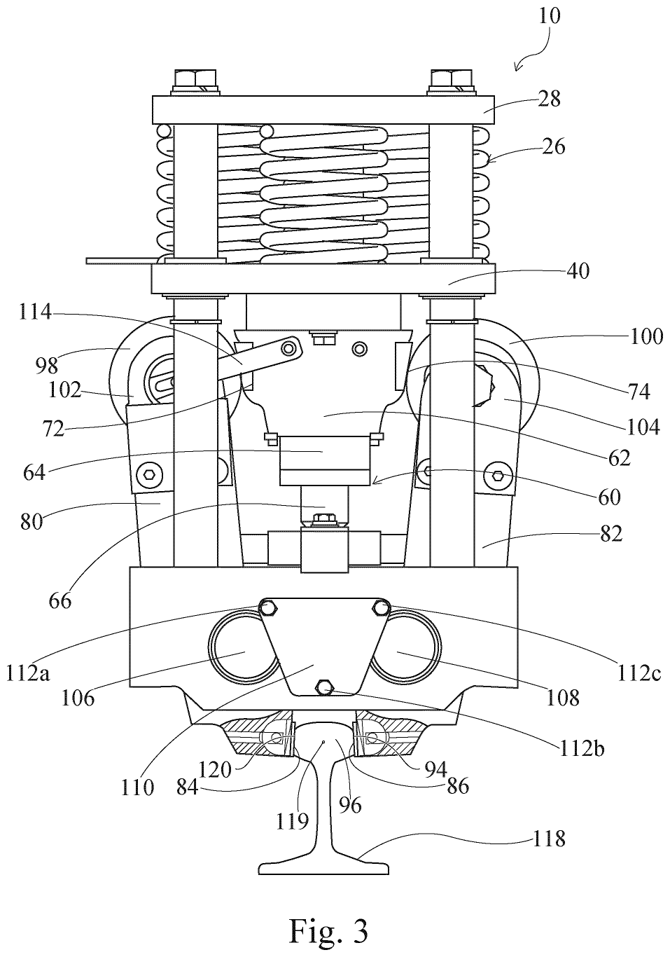

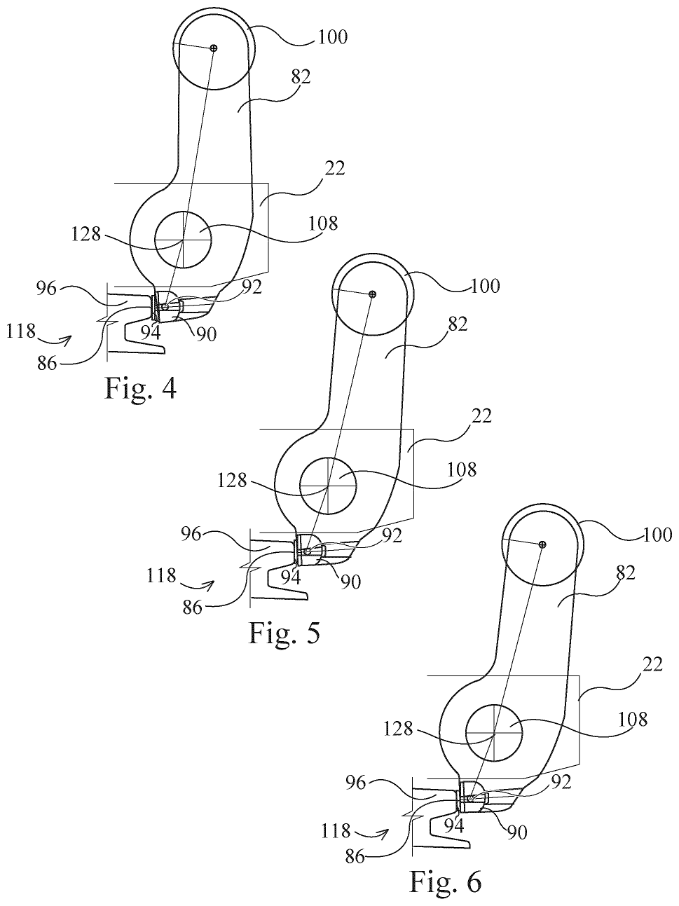

Referring now to FIGS. 2 and 3, the rail clamp 10 further includes a pair of opposed levers (or clamping levers) 80 and 82. Each of the levers 80 and 82 has a brake or friction pad 84 and 86 (which may be serrated, for example with vertical serrations), respectively, on or near a first end (or brake end) thereof as shown also for the lever 82 in FIGS. 4 to 6. The friction brake or friction pad 86 of the lever 82 is connected to a brake shoe 90, which is rotatably or pivotally connected to the lever 82 by a pivot pin 92 which, as described in more detail below, allows the brake pads 84 and 86 to remain parallel to a side 94 of a railhead 96 through movement of the lever 82. It will be understood by a person skilled in the art that the friction pad 84 of the lever 82 is configured in a similar manner and functions in a similar manner. However, the levers 80 and 82, the brake or friction pad 84 and 86, and the brake shoe 90 are examples only, and alternative embodiments may differ. For example, in alternative embodiments, a brake shoe and a brake pad may be rotatably connected to a lever in other ways.

Referring back to FIGS. 2 and 3, each of the levers 80 and 82 also has a cam follower in the form of a roller 98 and 100, respectively, on or near a bifurcated second end (or cam end) 102 and 104, respectively, opposite the first ends (or brake ends) of the levers 80 and 82. The levers 80 and 82 are each rotatably or pivotally connected to the mounting plates 22 and 24, both of which are shown in FIG. 1, by pivot pins 106 and 108 respectively. The pivot pins 106 and 108 are disposed between the brake pads 84 and 86 and the rollers 98 and 100 as shown in FIG. 2. The pivot pins 106 and 108 serve as pivots or fulcrums for the levers 80 and 82. The pivot pins 106 and 108 are retained in the mounting plates 22 and 24 by retainer plates 110. In FIG. 2, only a retainer plate 110 for one of the mounting plates 22 is shown. The retainer plate 110 is secured to the mounting plate 22 by three screws 112a, 112b and 112c. Linking bars 114 and 116 connect the levers 80 and 82, respectively, to the wedge 62. The rollers 98 and 100, the pivot pins 106 and 108, the retainer plate 110, and the linking bars 114 and 116 are examples only, and alternative embodiments may differ. For example, alternative embodiments may include one or more alternatives to the rollers 98 and 100, such as a toggle mechanism or one or more different cam followers or one or more other lever actuation points or regions, for example. Also, in alternative embodiments, levers may be rotatable about different respective fulcrums, or levers may be rotatable about respective fulcrums in other ways, for example.

FIG. 2 shows the rail clamp 10 in a released position. In the released position, hydraulic pressure from the cylinder 64 of the clamp actuator 60 urges the bottom plate 40 of the spring mechanism 26 away from a rail 118 upon which a crane (not shown) or other material-handling equipment (for example) may move. The springs 42, 44, 46, and 48 in the spring mechanism 26 are compressed and the wedge 62 is in a furthest position from the rail 118. The linking bars 114 and 116 retain the rollers 98 and 100 in communication with the wedge surfaces 72 and 74 while still ensuring proper clearance between the rail 118 and the brake pads 84 and 86. Accordingly, the wedge 62 remains extended between the rollers 98 and 100, with the wedge surfaces 72 and 74 in wedging contact with the rollers 98 and 100. In the released position, the rollers 98 and 100 are in contact with portions of the wedge surfaces 72 and 74 which generally have steeper slopes than the reminder of the wedge 62. Because hydraulic pressure from the cylinder 64 positions the rail clamp 10 in the released position, the rail clamp 10 may be referred to as a hydraulically released (or hydraulically releasable) rail clamp.

In order to engage the rail 118, hydraulic pressure is released from the cylinder 64 of the clamp actuator 60. This causes the springs 42, 44, 46, and 48 in the spring mechanism 26 extend and urge the bottom plate 40 of the spring mechanism 26 towards the rail 118. The bottom plate 40 of the spring mechanism 26 is operatively connected to the wedge 62 and is in slidable engagement with the guide posts 14, 16, 18, and 20. Accordingly, the guide posts 14, 16, 18, and 20 guide the movement of the bottom plate 40 and the wedge 62 towards to the rail 118. As the wedge 62 moves towards the rail 118, the rollers 98 and 100 roll along the wedge surfaces 72 and 74 of the wedge 62 and are wedged apart from one another. This causes the levers 80 and 82 to pivot about the pivot pins 106 and 108 and urges the brake pads 84 and 86 against sides 120 and 94 of the railhead 96 of the rail 118, thereby moving the rail clamp 10 to an engaged position which is shown in FIG. 3. Because the springs 42, 44, 46, and 48 position the rail clamp 10 in the engaged position, the rail clamp 10 may be referred to as a spring-actuated rail clamp, and more generally as a braking mechanism. To release the rail clamp 10 from the engaged position, hydraulic fluid is supplied to the cylinder 64 of the clamp actuator 60, causing the piston rod 66 to extend and the wedge 62 to move away from the rail 118 back to the position shown in FIG. 2.

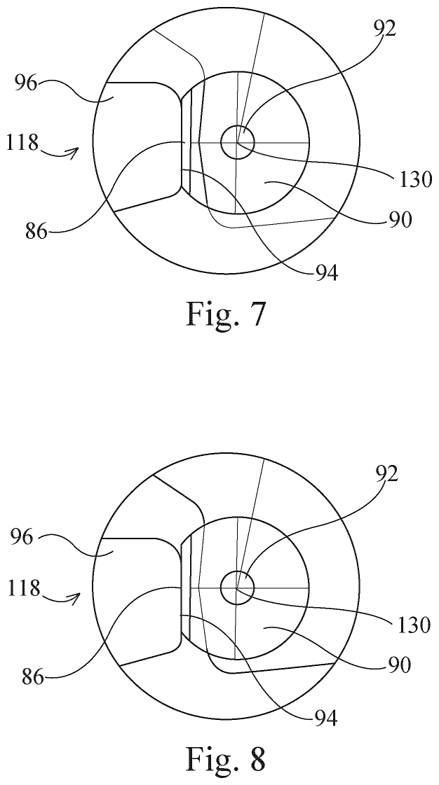

Rail 118 has a longitudinal rail axis 119, shown in FIGS. 2 and 3, which is perpendicular to the plane of the drawing. The levers 80 and 82 are pivotable about lever axes, as shown for axis 128 in FIGS. 4 to 6, which are coaxial with the pivot pins 106 and 108, respectively, and parallel to the longitudinal rail axis 119. As shown for lever 82, each brake shoe 90 is pivotable about a brake shoe axis 130, shown in FIGS. 7 and 8, which is coaxial with the pivot pin 92 and also parallel to the axes 128 of the pivot pins 106 and 108. This arrangement may ensure that pivoting of the brake shoe 90 about the brake shoe axis 130 ensures alignment between the brake pads 84 and 86 and the rail 118 for different pivotal positions of the levers with respect to the lever axes 126 and 128 as shown in FIGS. 4 to 6. However, the lever axes and brake shoe axes described above are examples only, and alternative embodiments may differ.

FIG. 4 shows the positions of the wedge 62, the lever 82, brake shoe 90, and brake pad 86 in the released position where the brake pad 86 is spaced apart from the side 94 of the railhead 96 of the rail 118. FIGS. 5 and 7 show the positions of the wedge 62, the lever 82, the brake shoe 90, and the brake pad 86 when the brake pad 86 begins to engage the rail 118. FIGS. 6 and 8 show the positions of the wedge 62, the lever 82, the brake shoe 90, and the brake pad 86 when the brake pad 86 fully engages the side 94 of the railhead 96 of the rail 118. It may be seen that pivoting of the brake shoe 90 about the brake shoe axis 130 may ensure alignment between the brake pad 86 and the side 94 of the railhead 96 of the rail 118 for different pivotal positions of the lever 82 with respect to the lever axis 128 as shown in FIGS. 4 to 6.

The wedge 62 and the levers 80 and 82 provide a mechanism ratio for clamping, which when multiplied by the spring force of the springs 42, 44, 46, and 48 acting on the bottom plate 40 of the spring mechanism 26, provides a clamping force which urges the brake pads 84 and 86 against the opposite sides 120 and 94 of the railhead 96 of the rail 118. As the springs 42, 44, 46, and 48 relax downwardly, the spring force of the springs 42, 44, 46, and 48 varies. Accordingly, if the mechanism ratio does not change, the resulting clamping force will vary. In the rail clamp 10 disclosed herein, the mechanism ratio changes when the rollers 98 and 100 roll along the variably sloped wedge surfaces 72 and 74 of the wedge 62. Such varying slopes are described in U.S. Pat. No. 7,975,811, for example. By appropriately varying the slopes of the wedge surfaces 72 and 74, the mechanism ratio changes to counteract changes in the spring force which results from spring extension and compression. Therefore, the rail clamp 10 may be referred to as a constant-force rail clamp. In other words, the rail clamp 10 is a wedge-style clamp, which maintains a constant braking or clamping force on the brake pads 84 and 86 against the opposite sides 120 and 94 of the railhead 96 of the rail 118 despite differences in spring force being applied.

Practically speaking and, with reference to FIG. 2, the narrower the width of the railhead 96 of the rail 118 contacted by the brake pads 84 and 86, the greater extension of the springs 42, 44, 46, and 48 that is required for the brake pads 84 and 86 to clamp against the opposite sides 120 and 94 of the railhead 96 of the rail 118. Therefore, the narrower the width of the rail head, the less spring force is available for clamping. Varying wedge angles of the wedge surfaces 72 and 74 compensate for the decreased spring force as the springs 42, 44, 46, and 48 extend and accordingly provide a substantially constant braking force across a variety of rail widths. Furthermore, as the brake pads 84 and 86 wear down, greater extension of the springs 42, 44, 46, and 48 is also required for the pads 84 and 86 to exert the clamping force on the opposite sides of the rail 118. The varying slopes of the wedge surfaces 72 and 74 of the wedge 62 accordingly adjust the mechanism ratio so that the clamping force is maintained substantially constant as the brake pads 84 and 86 wear down. Such constant clamping force may increase predictability for an operator of a conveyance on which the rail clamps 10 are used, which may increase safety.

It will be understood by a person skilled in the art that the application of a constantly applied force via a variable cam surface shall not be restricted to the braking mechanisms as illustrated in the Figures. It is applicable to any spring actuated mechanism and, for example, to mechanisms particularly sensitive to the loss of spring due to wear, for example, a spring actuated disc brake or clamp.

However, alternative embodiments may differ and may not necessarily be constant-force rail clamps, or alternative embodiments may achieve constant forces in different ways.

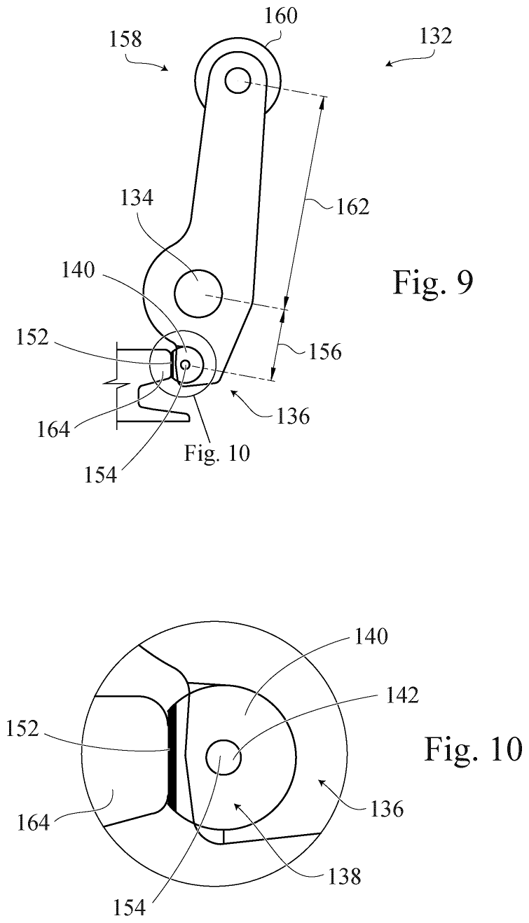

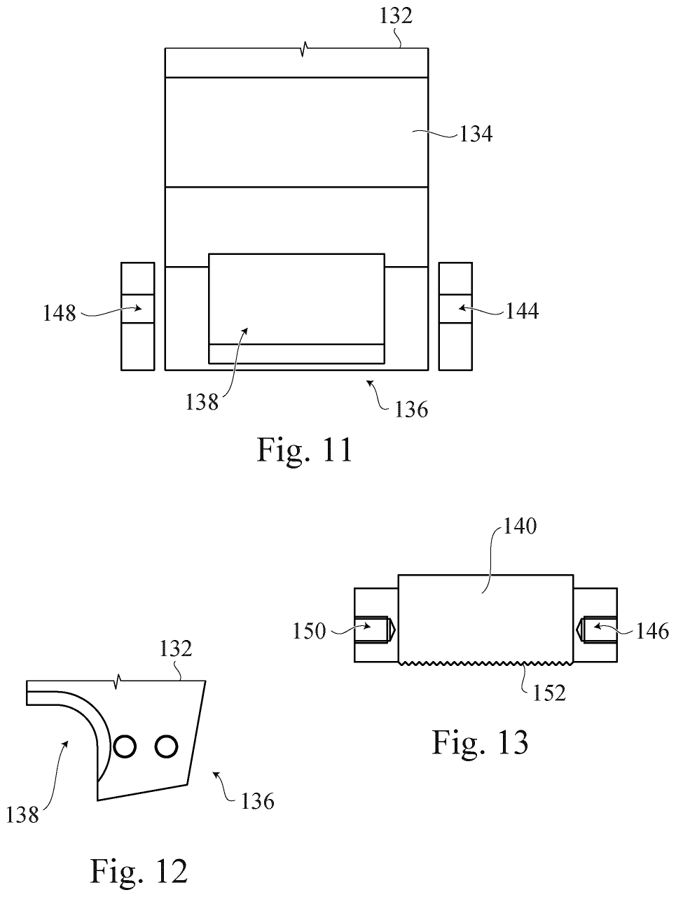

Referring to FIGS. 9 to 13, a lever (or clamping lever) according to another embodiment is shown generally at 132. The lever 132 is an alternative to the lever 80 or to the lever 82. Therefore, a rail clamp (such as the rail clamp 10 as described above, for example) may include one or more levers such as the lever 132, and the lever 132 may function in a constant-force rail clamp as described above, for example. Of course the lever 132 is an example only, and alternative embodiments may differ.

The lever 132 is rotatable or pivotable about a fulcrum defined by a pivot pin 134. On or near a first end (or brake end) shown generally at 136 of the lever 132, the lever 132 defines a space shown generally at 138 in a shoe housing (which may be a cylindrical shoe housing). The space 138 may be formed by machining and may be generally cylindrical. A brake shoe 140 may be positioned (or embedded) in the space 138 and may be held in the space 138 by a fastener 142 (such as a screw, a pin, a threaded pin, or one or more other fasteners) through a hole shown generally at 144 in the lever 132 and in a hole shown generally at 146 in the brake shoe 140, and by another fastener (such as a screw, a pin, a threaded pin, or one or more other fasteners) through a hole shown generally at 148 in the lever 132 and in a hole shown generally at 150 in the brake shoe 140. The brake shoe 140 may include a brake pad 152, which may be a serrated brake pad, for example with vertical serrations, and the brake shoe 140 and the brake pad 152 may be pivotable (or rotatable) about a brake shoe axis 154 at a lever-arm distance 156 from the fulcrum defined by the pivot pin 134. At or near a second end (or cam end) shown generally at 158 and opposite the first end (or brake end) 136, the lever 132 includes a cam follower or roller 160 (or one or more other lever actuation points or regions) at a lever-arm distance 162 from the fulcrum defined by the pivot pin 134.

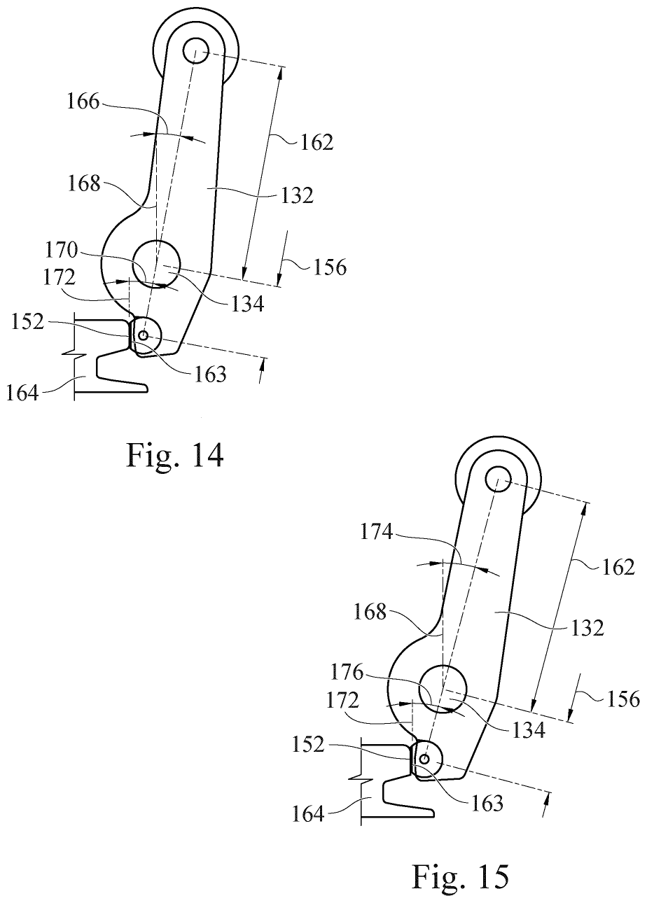

FIG. 14 illustrates an embodiment in which the brake pad 152 is urged against a contact surface 163 of a rail 164 when the rail 164 has a first thickness (for example, before wear of the rail 164 over time). In the embodiment of FIG. 14, the lever 132 rotates about the pivot pin 134 by an angle 166 from a reference line 168, which is vertical in the embodiment shown. As a result, the brake pad 152 rotates about the brake shoe axis 154 by an angle 170 from a reference line 172, which is also vertical in the embodiment shown.

FIG. 15 illustrates an embodiment in which the brake pad 152 is urged against the contact surface 163 of the rail 164 when the rail 164 has a second thickness less than the first thickness (for example, after wear of the rail 164 over time). In the embodiment of FIG. 15, the lever 132 rotates about the pivot pin 134 by an angle 174 from the reference line 168, and the angle 174 is greater than the angle 166 because of the reduced thickness of the rail 164. As a result, the brake pad 152 rotates about the brake shoe axis 154 by an angle 176 from the reference line 172, and the angle 176 is greater than the angle 170 because of the reduced thickness of the rail 164.

In other words, rotation of the brake pad 152 about the brake shoe axis 154 (as illustrated, for example by the difference between the angles 170 and 176) may keep the brake pad 152 parallel to the contact surface 163 of the rail 164 as the rail 164 varies in thickness, for example due to wear of the rail 164 over time. As a result, the brake pad 152 may better engage the contact surface 163 when compared to brake pads that do not rotate about brake shoe axes as described herein, for example. Further, the ratio of the lever-arm distances 156 and 162 may remain constant as the rail 164 varies in thickness, for example due to wear of the rail 164 over time, which may keep force of the brake pad 152 on the contact surface 163 constant as the rail 164 varies in thickness, for example due to wear of the rail 164 over time. Rotation of the brake pad 152 about the brake shoe axis 154 may also accommodate different or varying taper angles of the contact surface 163. Of course, rotation of the brake pads 84 and 86 about their respective brake shoe axes may facilitate similar functionality.

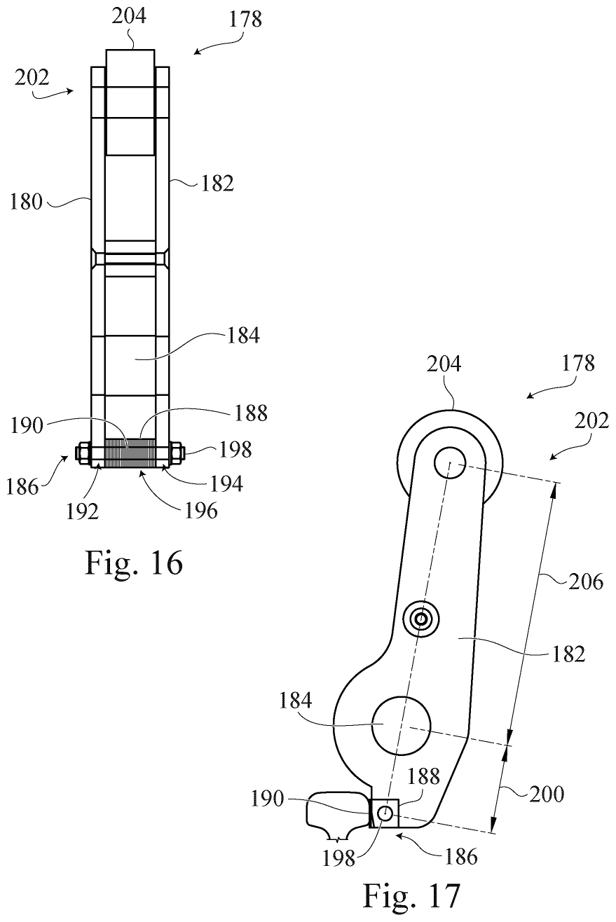

Referring to FIGS. 16 and 17, a lever (or clamping lever) according to another embodiment is shown generally at 178. The lever 178 is another alternative to the lever 80 or to the lever 82. Therefore, a rail clamp (such as the rail clamp 10 as described above, for example) may include one or more levers such as the lever 178, and the lever 178 may function in a constant-force rail clamp as described above, for example. Of course the lever 178 is another example only, and alternative embodiments may differ.

The lever 178 is a composite lever including two lever plates 180 and 182 (although alternative embodiments may include more than two lever plates) and is rotatable or pivotable about a fulcrum defined by a pivot pin 184. On or near a first end (or brake end) shown generally at 186 of the lever 178, the lever 178 includes a shoe block 188 including a brake shoe 190, which may have serrations, which may be vertical. A through-hole shown generally at 192 in the lever plate 180, a through-hole shown generally at 194 in the lever plate 182, and a through-hole shown generally at 196 in the shoe block 188 may receive a fastener 198 (such as a screw, a pin, a threaded pin, or one or more other fasteners) such that the shoe block 188 and the brake pad 190 may be pivotable (or rotatable) about a brake shoe axis at a lever-arm distance 200 from the fulcrum defined by the pivot pin 184. Rotation of the brake pad 190 about the brake shoe axis may facilitate functionality similar to the functionality described above regarding rotation of the brake pads 84 and 86 about their respective brake shoe axes or regarding rotation of the brake pad 152 about the brake shoe axis 154. At or near a second end (or cam end) shown generally at 202, the lever 178 includes a cam follower or roller 204 (or one or more other lever actuation points or regions) at a lever-arm distance 206 from the fulcrum defined by the pivot pin 184.

It will be understood by someone skilled in the art that many of the details provided above are by way of example only and are not intended to limit the scope of the invention which is to be determined with reference to the following claims.

1. A braking mechanism for a rail, the braking mechanism comprising:
a frame;
a first lever mounted to the frame for rotation about a first fulcrum; and
a first brake shoe rotatably connected to the first lever for rotation about a first brake shoe axis spaced apart from the first fulcrum, the first brake shoe comprising a first brake pad and positioned to press against the rail.

2. The braking mechanism as claimed in claim 1 wherein the first lever is pivotally mounted to the frame for pivoting about a first lever axis spaced apart from the first brake shoe axis.

3. The braking mechanism as claimed in claim 2 wherein the first brake shoe axis is parallel to the first lever axis.

4. The braking mechanism as claimed in claim 1 wherein the first brake shoe is pivotally connected to the first lever for pivoting about the first brake shoe axis.

5. The braking mechanism as claimed in claim 1 further comprising:
a second lever mounted to the frame for rotation about a second fulcrum; and
a second brake shoe rotatably connected to the second lever for rotation about a second brake shoe axis spaced apart from the second fulcrum, the second brake shoe comprising a second brake pad and positioned to press against the rail;
the first and second brake pads spaced apart from each other to receive the rail between the first and second brake pads and to clamp the rail between the first and second brake pads when the first and second levers are rotated about the first and second fulcrums respectively to press the first and second brake pads against the rail.

6. The braking mechanism as claimed in claim 5 wherein the second lever is pivotally mounted to the frame for pivoting about a second lever axis spaced apart from the second brake shoe axis.

7. The braking mechanism as claimed in claim 6 wherein the second brake shoe axis is parallel to the second lever axis.

8. The braking mechanism as claimed in claim 5 wherein the second brake shoe is pivotally connected to the second lever for pivoting about the second brake shoe axis.

9. The braking mechanism as claimed in claim 5 further comprising at least one resilient body biasing the first and second brake pads towards engagement with the rail.

10. The braking mechanism as claimed in claim 9 wherein the at least one resilient body is a spring mechanism.

11. The braking mechanism as claimed in claim 9 further comprising a clamp actuator actuatable to counter the at least one resilient body by moving the first and second brake pads away from engagement with the rail.

12. The braking mechanism as claimed in claim 11 wherein the clamp actuator comprises a cam mechanism.

13. The braking mechanism as claimed in claim 12 wherein:
the first brake pad and the first brake shoe are near a brake end of the first lever;
the second brake pad and the second brake shoe are near a brake end of the second lever;
the braking mechanism further comprises a first cam follower near a cam end of the first lever opposite the brake end of the first lever and positioned to contact a first cam surface of the cam mechanism such that movement of the cam mechanism causes rotation of the first lever about the first fulcrum; and
the braking mechanism further comprises a second cam follower near a cam end of the second lever opposite the brake end of the second lever and positioned to contact a second cam surface of the cam mechanism such that movement of the cam mechanism causes rotation of the second lever about the second fulcrum.

14. The braking mechanism as claimed in claim 13 wherein:
the first cam follower is a first roller rotatably mounted on the first lever; and
the second cam follower is a second roller rotatably mounted on the second lever.

15. The braking mechanism as claimed in claim 13 wherein the first and second cam surfaces are variably sloped.

16. A braking system comprising:
the braking mechanism as claimed in claim 1; and
the rail positioned such that the first brake pad is positionable to press against the rail in response to rotation of the first lever about the first fulcrum.

17. The braking system of claim 16 wherein the braking mechanism further comprises:
a second lever mounted to the frame for rotation about a second fulcrum; and
a second brake shoe rotatably connected to the second lever for rotation about a second brake shoe axis spaced apart from the second fulcrum, the second brake shoe comprising a second brake pad and positioned to press against the rail;
the first and second brake pads spaced apart from each other to receive the rail between the first and second brake pads and to clamp the rail between the first and second brake pads when the first and second levers are rotated about the first and second fulcrums respectively to press the first and second brake pads against the rail;
wherein the rail is positioned such that the second brake pad is positionable to press against the rail in response to rotation of the second lever about the second fulcrum.

18. A method of operating the braking system of claim 16 wherein the braking mechanism further comprises:
a second lever mounted to the frame for rotation about a second fulcrum;
a second brake shoe rotatably connected to the second lever for rotation about a second brake shoe axis spaced apart from the second fulcrum, the second brake shoe comprising a second brake pad and positioned to press against the rail;
at least one resilient body biasing the first and second brake pads towards engagement with the rail; and
a clamp actuator actuatable to counter the at least one resilient body by moving the first and second brake pads away from engagement with the rail;
the first and second brake pads spaced apart from each other to receive the rail between the first and second brake pads and to clamp the rail between the first and second brake pads when the first and second levers are rotated about the first and second fulcrums respectively to press the first and second brake pads against the rail;
wherein the clamp actuator comprises a cam mechanism;
the method comprising causing the first and second brake pads to move away from engagement with the rail;
wherein causing the first and second brake pads to move away from engagement with the rail comprises causing the cam mechanism to move.

19. A crane comprising the braking mechanism as claimed in claim 1.

20. Material-handling equipment comprising the braking mechanism as claimed in claim 1.
